(19) United States
(12) Patent Application Publication
(10) Pub. No.: US 2015/0172417 A1
(43) Pub. Date: Jun. 18, 2015

(54) Systems and Methods for Determining the Operating Status of an Entity Having Operating Hours

(71) Applicant: Google Inc., Mountain View, CA (US)

(72) Inventor: Wojciech Moczydlowski, Forrest Hills, NY (US)

(73) Assignee: Google Inc., Mountain View, CA (US)

(21) Appl. No.: 13/763,006

(22) Filed: Feb. 8, 2013

(51) Int. Cl. H04L 29/06

(52) U.S. Cl. CPC H04L 67/42

(57) ABSTRACT

Provided are systems and methods for determining the operating status of an entity. In some embodiments, a locking device, such as a lock or latch, may be moved between an open position and a closed position. When moved to the open position, the locking device may engage with a sensor. Upon engagement with the sensor, a status signal may be wirelessly transmitted from the entity and detected by a client computer. Upon detection of the status signal, a notification may be transmitted to a server. The notification may include a timestamp and an entity identifier, or a timestamp may be determined upon receipt of the notification. The entity identifier and timestamp may be stored as an indicator of the status of the entity as of the timestamp. Multiple status timestamps may be accumulated and analyzed to determine the operating status or operating hours of the entity.

### BACKGROUND OF THE INVENTION

1. Field of the Invention

This invention relates generally to improving information about a business or other entity, and more particularly, to determining the operating status of a business or other entity having operating hours.

2. Description of the Related Art

The Internet and the World Wide Web (WWW) are useful for a variety of purposes. For example, users may use the Internet to retrieve information about businesses, government offices, public places such as parks and libraries, etc. Some of the information for these entities may be available from a third party, such as a website listing information for businesses, parks, and other points of interest in a geographic area. The information on such websites may include different information about a business or other entity, such as the name of the business, the location of the business, the menu if the business is restaurant, etc.

Some of the websites and other applications may purport to list the operating hours of the business. However, the operating hours may be incorrect or unverified, and such misinformation may result in users visiting the business outside of the actual operating hours. Moreover, obtaining the operating hours for a business or other entity may be time-consuming and challenging, and may require contacting the business and other entities directly. Additionally, obtaining the operation hours for a business or other entity may involve reliance on inaccurate sources, such as users manually reporting the operating hours, outdated websites, or other unreliable data sources.

### SUMMARY OF THE INVENTION

Various embodiments of methods and apparatus for determining the operating status of an entity are provided herein. In some embodiments, provided is a computer-implemented method for determining the operating status of an entity. The method includes receiving over a network, at one or more processors, a plurality of transmissions from a respective plurality of client computers, each transmission generated in response to the detection of a wireless signal corresponding to a position of a locking device of an entity having an open status and a closed status, wherein the locking device is in a first position when the entity has the open status and a second position when the entity has the closed status, and the transmission having a timestamp and a first entity identifier corresponding to the entity. The method further includes accumulating, by the one or more processors, a respective plurality of timestamps of the received plurality of transmissions, determining based on the stored timestamps, by one or more processors, an operating status of the entity, and storing, on a memory accessible by the one or more processors, the operating status for the entity in a database entry for the entity.

Additionally, in some embodiments, a non-transitory tangible computer-readable storage medium is provided having executable computer code stored thereon for determining the operating status of an entity. The code having a set of instructions that causes one or more processors to perform the following: receiving over a network, at one or more processors, a plurality of transmissions from a respective plurality of client computers, each transmission generated in response to the detection of a wireless signal corresponding to a position of a locking device of an entity having an open status and a closed status, wherein the locking device is in a first position when the entity has the open status and a second position when the entity has the closed status and the transmission having a timestamp and a first entity identifier corresponding to the entity; accumulating, by the one or more processors, a respective plurality of timestamps of the received plurality of transmissions; determining based on the stored timestamps, by one or more processors, an operating status of the entity; and storing, on a memory accessible by the one or more processors, the operating status for the entity in a database entry for the entity.

Further, in some embodiments, a system for determining the operating status of an entity is provided. The system includes one or more processors, a database accessible by the one or more processors, and a memory accessible by the one or processors, the memory configured to store computer code. The code has a set of instructions that causes one or more processors to execute the following: receiving over a network, at one or more processors, a plurality of transmissions from a respective plurality of client computers, each transmission generated in response to the detection of a wireless signal corresponding to a position of a locking device of an entity having an open status and a closed status, wherein the locking device is in a first position when the entity has the open status and a second position when the entity has the closed status and the transmission having a timestamp and a first entity identifier corresponding to the entity; accumulating, by the one or more processors, a respective plurality of timestamps of the received plurality of transmissions; determining based on the stored timestamps, by one or more processors, an operating status of the entity; and storing, by the one or more processors, the operating status for the entity in the database.

### BRIEF DESCRIPTION OF THE DRAWINGS

FIGS. 1A and 1B are schematic diagrams illustrating a system in accordance with an embodiment of the present invention;

FIGS. 2A and 2B are block diagrams depicting operation of a sensor for detection of actuation of a locking device in accordance with an embodiment of the present invention;

FIGS. 3A and 3B are block diagrams of a process for determining a status of an entity from transmitted signals in accordance with an embodiment of the present invention;

FIG. 4 is a block diagram of a data structure for transmitting and storing entity status data in accordance with an embodiment of the present invention;

FIG. 5 is a block diagram of a verification process for entity status data in accordance with an embodiment of the present invention;

FIG. 6 is a schematic of a screenshot depicting the display of entity status data in accordance with an embodiment of the present invention; and

FIG. 7 is a block diagram of a computer in accordance with an embodiment of the present invention.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems and methods for determining the operating status of an entity having operating hours. A door, window, or other structure of an entity may include a locking device such as a lock, latch, etc. To open the entity for business, the door, window, or other structure may be opened by moving the locking device to an open position. When moved to the open position, the locking device may engage with a sensor. Upon engagement with the sensor, a status signal may be wirelessly transmitted from the entity. When the structure is opened and the status signal is transmitted, the detection of the signal may be an indication that the entity is open. In some embodiments, the status signal may include an identifier for the entity, such a cryptographic signature.

The transmitted status signal may be detected by a portable electronic device in proximity to the entity, such as when a user of the portable electronic device walks by the entity. Upon detection of the status signal, the portable electronic device may transmit a notification over a network to a server (e.g., one or more servers). The notification may include a timestamp and an entity identifier, or a timestamp may be determined upon receipt of the notification. The entity identifier and timestamp may be stored as an indicator of the status of the entity as of the timestamp, i.e., that the entity is open at that time indicated by the timestamp. The status of the entity may be displayed in response to requests for information about the entity. In some embodiments, the status of the entity may be annotated to search results that include the entity. Additionally, in some embodiments, multiple status timestamps may be accumulated and analyzed to determine the operating status or operating hours of the entity. Additionally, the status of an entity may be compared and verified against another status obtained for an entity.

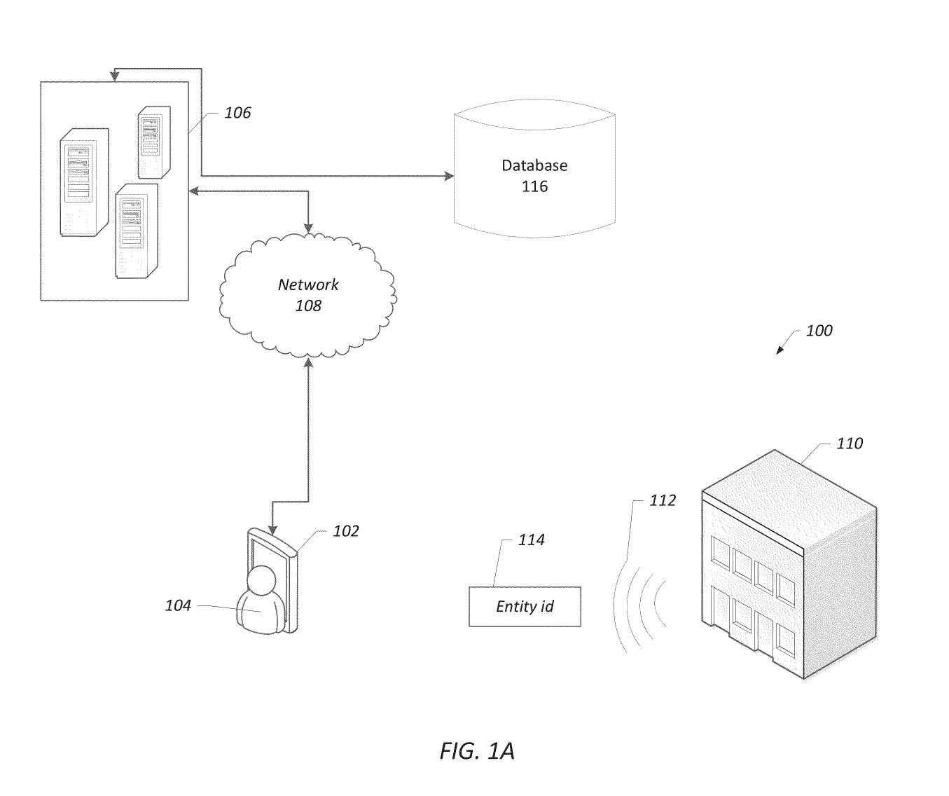

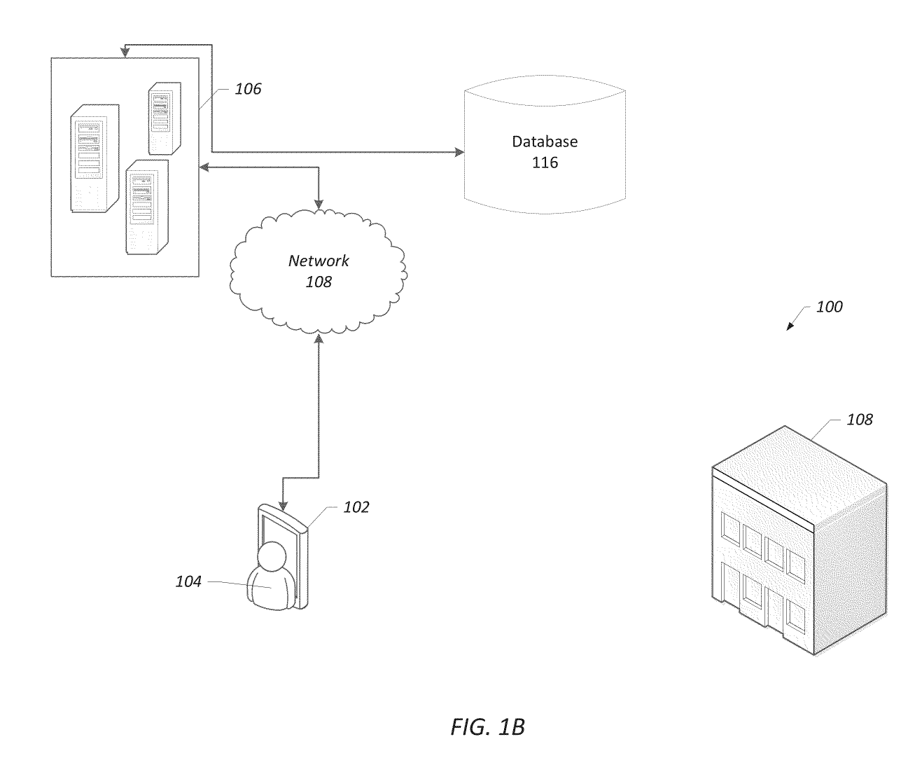

FIGS. 1A and 1B illustrate a system 100 in accordance with embodiments of the present invention. As shown in FIG. 1, the system 100 may include a client computer 102 used by a user 104. The client computer 102 may be capable of communicating with servers 106 over a network 108, such that the client computer 102 may transmit data to and receive data from the servers 106. The client computer 102 may include, for example, smartphones, tablet computers, laptop computers, personal digital assistants, desktop computers, etc. The servers 106 may include a single server (in a discrete hardware component or as a virtual server) or multiple servers. The servers 106 may include web servers, application servers, or other types of servers. The servers 106 may be, for example, computers arranged in any physical and virtual configuration, such as computers in one or more data processing centers, a distributed computing environment, or other configuration. Such configurations may use the network 108 for communication or may communicate over other networks. The network 108 may include any suitable network, such as the Internet, an intranet, a local area network (LAN), a wide area network (WAN), or any other suitable network implemented using any suitable protocols.

The servers 106 may include a geographic information system (GIS), a search engine, web services, or any combination of these systems. The client computer 102 may communicate obtain data from the servers 106 and transmit data to the servers 106. For example, the client computer 102 may communicate with the servers 106 to retrieve a web page, an interactive map, the date and time, calendar information, contacts, digital media such as video music, pictures, etc. Additionally, the client computer 102 may execute various applications to enable the user 104 to interact with the servers 106, other users, and other portable computers. Such applications may include browsers, map applications, social networking applications, location-based services, media players, etc.

As also shown in FIGS. 1A and 1B, the system 100 may include an entity 110 having operating hours. As used herein, the term “entity” refers to a private or public entity having a physical location, such as a business (e.g., restaurant, bar, store, etc.), a public facility (e.g., a park, library, etc.), a government office (e.g., Department of Public Safety (DPS) office, courthouse), etc. As noted above, such entities may have an operating status, such as an “open” status during which the entity is open and accessible to a user, and a “closed” status for which the entity is closed and inaccessible to a user. Moreover, such entities may have operating hours. The operating hours for an entity may define the time period an entity is open and accessible to a user and when the entity is closed and not accessible to a user. For example, the operating hours may define when a user may shop at a business, enter a public facility, conduct transactions at a government office, etc.

As described below, a signal 112 may be continuously transmitted (e.g., broadcast) from the entity 110 based on the position of a locking device, such as a lock, latch, etc., of a door, window, or other structures of the entity 110. When the entity 110 is open, such doors, windows, or other structures are also typically opened. Thus, when the locking device is moved to a position to open the door, window, or other structure, the signal 112 may be continuously transmitted from the entity 110 based on the position of the locking device. The transmission of the signal 112 indicates that the entity 110 is open. Additionally, the signal 112 may include information about the entity 110, such as an entity identifier 114. The entity identifier 114 may be encrypted (e.g., a cryptographic signature).

As a user 104 and client computer 102 come within proximity of the entity 110, the portable electronic device 102 may detect the signal 112. For example, the portable electronic device 102 may execute an application that “listens” for such signals and performs an action upon detection of the signal 112. After detection of the signal 112, the portable electronic device 102 may transmit the detection and a timestamp to the servers 108. The receipt of this signal may indicate that the entity 110 is open at the time indicated by the timestamp, and the servers 108 may store this status and provide the entity's status to other systems and processes (e.g., search engines). The entity's status as of the time indicated by the timestamp may be displayed to a user, such as by annotating the entity's status to search results that include the entity.

In some embodiments, the portable electronic device 102 may transmit the notification periodically based on the detection of the signal 112. For example, if the signal 112 is continuously transmitted over a duration of time, the portable electronic device 102 may periodically transmit the notification, such as every minute, every five minutes, every ten minutes, every hour, etc. In such embodiments, each notification provides the status of the entity 110 as of the time indicated by the timestamp of the notification.

In contrast, as shown in FIG. 1B, when the entity 110 is closed, the doors, windows, or other structures of the entity 110 may be closed and the locking device may be in a closed position. When the locking device is in the closed position, the signal 112 is no longer transmitted. When the user 104 and portable electronic device 102 come within proximity of the entity 110, no signal is detected and no detection is transmitted to the servers 108.

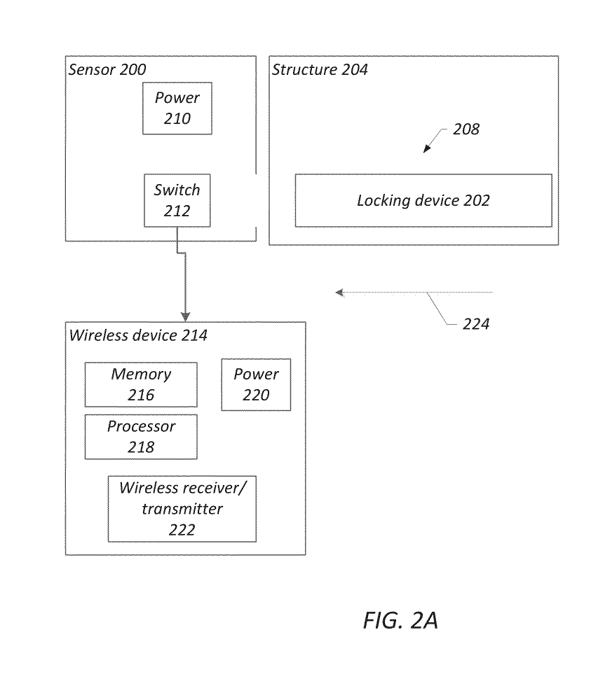

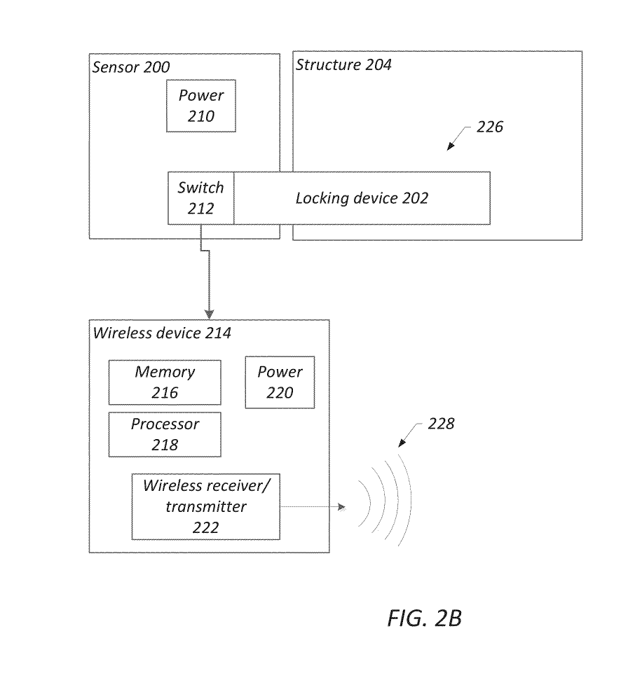

FIGS. 2A and 2B depict operation of a sensor 200 for detecting actuation of a locking device 202 coupled to a structure 204 of an entity in accordance with embodiments of the present invention. FIG. 2A depicts a first position 208 of the locking device 202 when the structure 204 is closed, such as when the entity is closed. As noted above, the locking device 202 may include a latch, lock, or other mechanical part of the structure. In other embodiments, the locking device 202 may be a separate mechanical part coupled to a latch, lock, or other locking device of the structure. In other embodiments, the sensor 200 may include other devices for detecting movement of the locking device 202, such as infrared sensors, optical sensors, etc.

The sensor 200 may include a power source 210, e.g., a battery, and a switch 212 configured to respond to a position of the locking device 202. The sensor 200 may be in communication with a wireless device 214, e.g., wireless router. The wireless device 214 may include a memory 216, a processor 218, a power source 320, and a wireless interface (e.g., a receiver and a transmitter) 222. The wireless interface 222 may receive and transmit wireless signals over any suitable wireless protocol, such as IEEE 802.11x.

As shown in FIG. 2A, when the structure 204 is in a closed position, such as when an entity is closed, the locking device 202 may be in the first position 202 and disengaged from the switch 212 of the sensor 200. The switch 212 does not send any signal to the wireless device 214, and no operating status signal is transmitted from the wireless device 214.

When the structure 204 is in an open position, such as when an entity is open, the locking device 202 may be moved to a second position 226, such as by moving the locking device 202 in the direction indicated by arrow 224. As shown in FIG. 2B, in the second position the locking device 202 may engage the switch 212. For example, the locking device 202 may mechanically and/or electrically engage the switch 212.

After engaging the switch 212, the switch 212 may transmit a signal to the wireless device 214. Upon receiving the signal from the switch 212, the wireless device 214 may transmit an operating status signal 228 via the wireless interface 222. As mentioned above, the operating status signal 228 may include an entity identifier and the identifier may be encrypted. The entity identifier may be stored in the memory 216 and the encryption of the identifier may be performed by the processor 218. Additionally, other types of information may be stored in the memory 216 and provided with the signal 228. In other embodiments, the wireless interface and other components may be integrated in a sensor. For example, the sensor may include a memory, a processor, and a wireless interface, and may transmit wireless signals based on engagement of a locking device that moves between a first position and a second position.

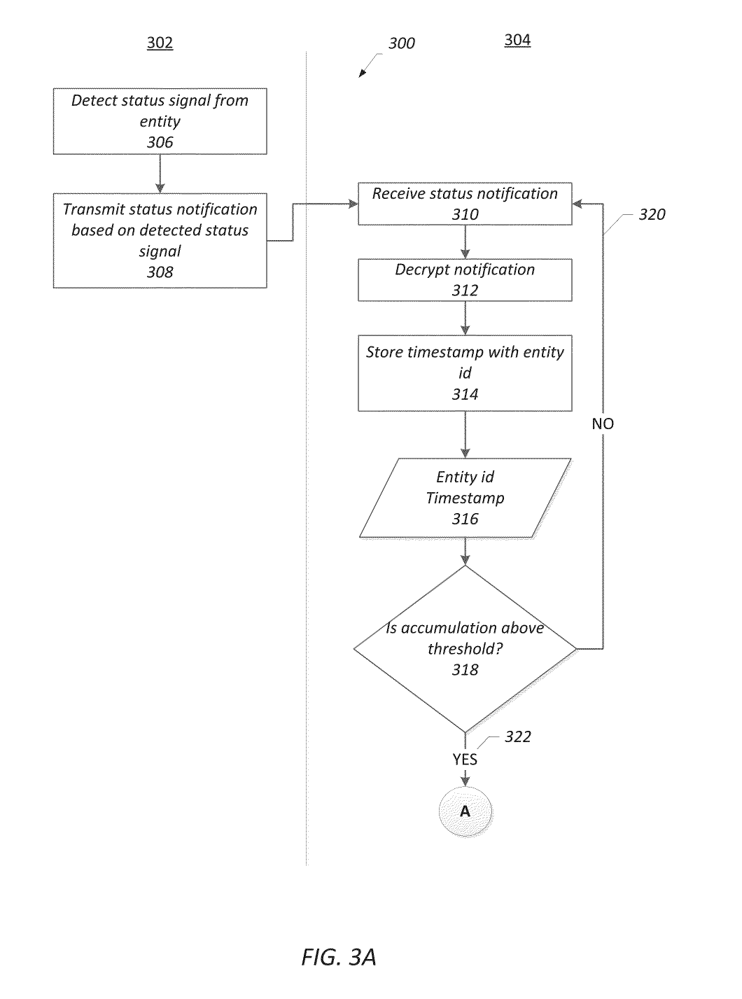

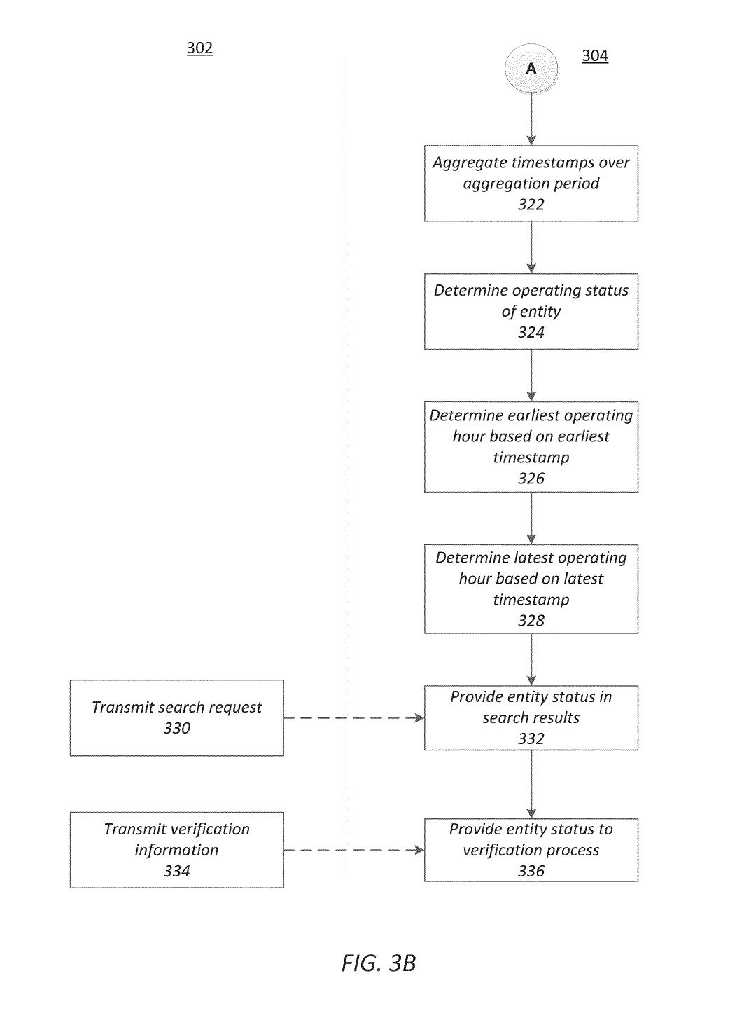

FIGS. 3A and 3B depict a process 300 for determining an “open” status of an entity in accordance with an embodiment of the present invention. FIGS. 3A and 3B also depict a client side 302 and a server side 304 indicating those process steps that may be performed on a client and a server respectively. Some or all steps of the process 300 may be implemented as executable code instructions stored on non-transitory tangible computer-readable media and executed by one or more processors.

As shown in FIG. 3A, a status signal transmitted from an entity may be detected by a client (block 306), such as by a portable electronic device within proximity of the entity. Upon detecting the status signal, status notifications may be transmitted (block 308) over a network, such as from the portable electronic device to servers in communication with the network. Status notifications may be received (block 310), such as from multiple portable electronic devices over a duration of time. For example, portable electronic devices within proximity to an entity at different times over several days, weeks, or months may transmit notifications over a network.

In some embodiments, the notification, or data included in the notification, may be decrypted (block 312). For example, the notification may include a cryptographic signature, such as an encrypted entity identifier, and the cryptographic signature may be decrypted to obtain the entity identifier. Next, a timestamp may be associated and stored with an entity identifier (block 314), such as the entity identifier transmitted in the status notification. In some embodiments, a second entity identifier may be determined based on the entity identifier transmitted in the status notification, and the second entity identifier may be stored with the timestamp. As described above, the stored entity identifier and timestamps 316 may provide an indicator that the entity is open as of the time indicated by the timestamp. Multiple timestamps may be accumulated and stored for an entity.

Next, the accumulated timestamps may be evaluated to determine if enough timestamps have been received and stored for an entity to generate operating hours for the entity. The accumulation may be compared to a threshold (block 318), such as a duration of time, a number of records, etc. If the accumulation is below the threshold, additional notifications may be received (line 320). If the accumulations are above the threshold (line 322), the accumulated timestamps may be further processed (block A).

The process 300 is further illustrated in FIG. 3B, as indicated by connection block A. In some embodiments, the timestamps for an entity may be aggregated over an aggregation period (block 322). For example, the timestamps may be aggregated over a single day, multiple days, a week, multiple weeks, a month, multiple months, etc. The aggregated timestamps may be used to determine the operating hours of an entity (block 324), such as whether an entity is “open” or “closed” at a specific time. In some embodiments, the earliest operating hour for the entity may be determined based on the earliest timestamp (block 326), i.e., the timestamp that corresponds to the earliest received status signal and transmitted notification. The operating hour may be determined by rounding the timestamp of the earliest open status to the nearest hour. For example, if the timestamp of the earliest open status is 8:18 AM, the earliest operating hour for the entity may be determined to be 8:00 AM. In other embodiments, different statistical techniques may be used to determine the earliest operating hour based on the accumulated timestamps.

Additionally, the latest operating hour for the entity may be determined based on the latest timestamp, i.e., the timestamp that corresponds to the latest received status signal and transmitted notification (block 328). The operating hour may be determined by rounding the timestamp of the latest open status to the latest hour. For example, if the timestamp of the latest open status is 6:52 PM, the latest operating hour for the entity may be determined to be 7:00 PM. In other embodiments, different statistical techniques may be used to determine the latest operating hour based on the accumulated timestamps.

This open status may be provided for different uses and processes. In some embodiments, the open status may be provided in response to a search having the entity in the search results. For example, a search request may be transmitted from a client (block 330) and received by a server. In response, the entity status may be provided in the search results (block 332), such as by annotating the status of the entity as of the time of the search request in the search results. Additionally, in some embodiments, as described below, verification information for an entity may be transmitted from a client (block 334). As described below, the verification information may include a status of an entity verified by a user, such as when a user observes the status of an entity. Additionally, the entity status at a specific time may be provided to a verification process (block 336). For example, the “open” status of an entity at a specific time may be compared to the verification information and may be used to confirm the operating status of an entity or trigger a re-verification process if there is a conflict in the data.

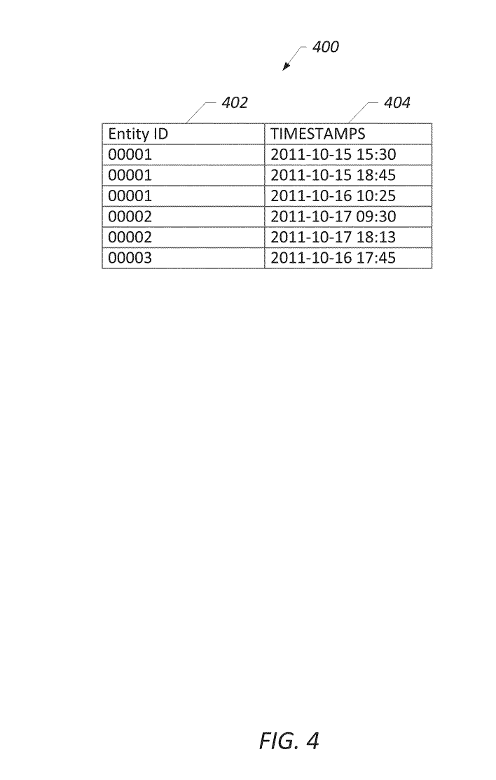

FIG. 4 depicts a data structure 400 for storing entity status data, such as timestamps, in accordance with an embodiment of the present invention. The data structure 400 may be any suitable data structure, such as a table, key-value pairs, etc. The data structure 400 may include fields such as an entity identifier field 402 and timestamp field 404. The entity identifier field 402 may store an entity identifier for a received notification, and the timestamp 404 may store the timestamp of the received notification. Thus, each entry in the data structure 400 may correspond to an instance of detection of an entity's status signal by a portable electronic device based on the subsequent transmission of a notification from the portable electronic device.

In some embodiments, the data structure 400 may include other information, such as verification field, a conflicts field, or other information. The verification field may indicate if an “open” status at the time indicated by the timestamp has been verified, such as by comparing with existing data. For example, the verification field may include a “Y” or N″ to indicate verification. The conflicts field may indicate if there is a conflict with existing data, such as by comparison to existing operating hours for an entity.

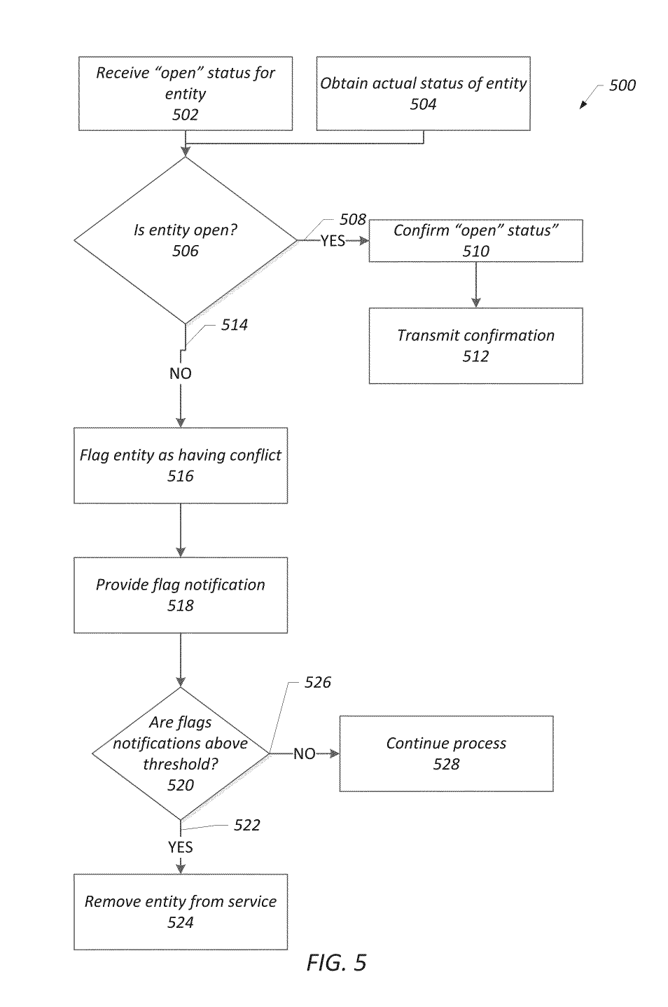

In some instances, an entity may actually be closed but a status signal may be still be transmitted from the entity. For example, an entity may leave a door, window, or other structure open and the corresponding locking device may be in position to cause transmission of the status signal. FIG. 5 depicts an embodiment of a verification process 500 for detecting and responding to conflicts between entity status data and an entity's actual status in accordance with an embodiment of the present invention. Initially, a timestamp corresponding to an entity's status signal, as determined from a transmitted status notification, may be obtained (block 502), such as from a stored entity identifier and timestamp. The actual status of the entity may be obtained through any suitable technique, such as directly contacting the entity, receiving the actual status of the entity from user feedback (e.g., from a link to report if an entity is open or closed), or other sources, etc. If the entity is open (line 508), the entity's open status may be confirmed (block 510). The confirmation may be stored or transmitted (block 512) for further processing. For example, those entities having a confirmed “open” status may be annotated with “CONFIRMED” or other text when the entities are provided in search results or other listings.

If the entity is closed (line 514), a “conflict” indicator may be assigned and associated with the entity. For example, the entity may be flagged (block 516) as having a status that conflicts with the obtained status timestamp. The flagging may include associating an indicator with the entity that indicates if the entity is in conflict with status timestamp data. Based on the flagging, a flag notification may be provided (block 518) to another process or used to display status information to a user. For example, the flag notification may be transmitted to a verification service to verify the status of the entity or the operation of the sensor and locking device for generating the status signal. In other embodiments, the flag notification may be providing to a system for monitoring entities and determining the number of flag notifications received for each entity. The number of flag notifications may be compared to a threshold (block 520). If the number of flag notifications are above a threshold (line 522), the entity may be removed from an operating status service (block 524) that enables the determination of the entity's status. If the number of flag notifications are below the threshold (line 526), then the process may continue (block 528), such as by waiting for receipt of an actual status for another entity.

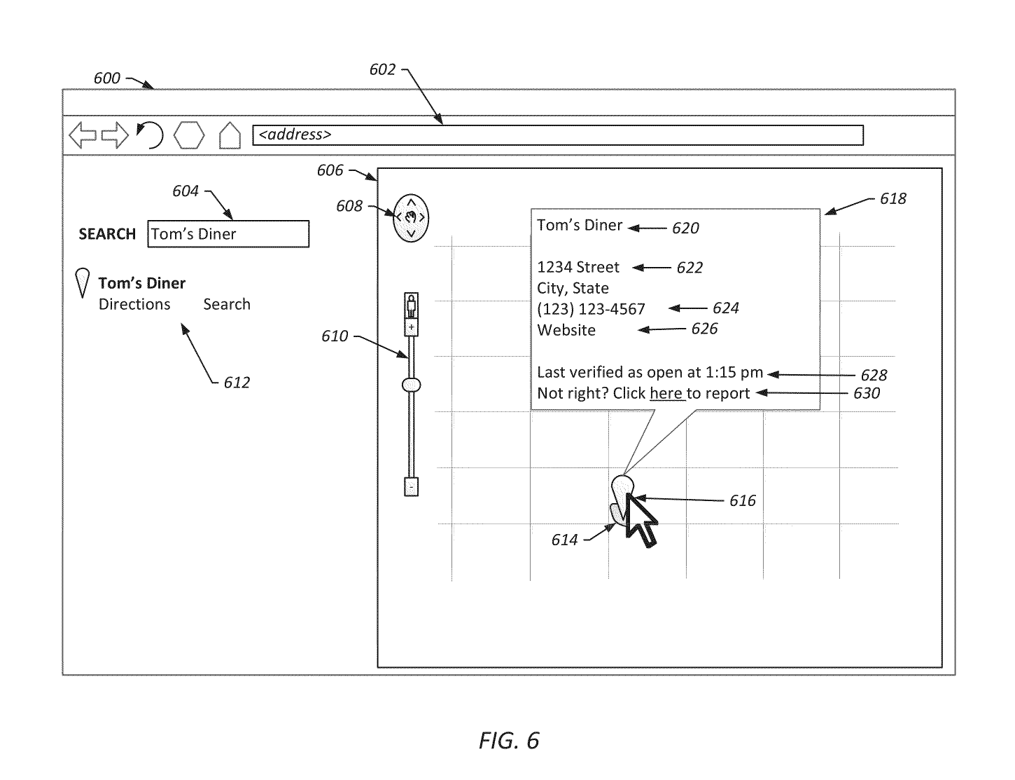

FIG. 6 depicts a screenshot 600 illustrating the display of estimated operating hours in accordance with an embodiment of the present invention. The illustrated screenshot 600 may be from a display on a client computer, such as the portable computer described above. The illustrated screenshot 600 and displayed information may be displayed by an application executed on the computer, such as a browser displaying a web application. In other embodiments, the information depicted in screenshot 600 may be displayed by an interactive map application executing on a portable computer (e.g., Google Maps™).

The screenshot 600 depicts an address field 602 (e.g., an address field of a browser), a search field 604 (e.g., a search field of an application), and an interactive map 606. The interactive map 606 may include a pan button 608 that enables a user to pan the interactive map 606 and a zoom slider 610 that enables a user to zoom in and zoom out of the interactive map 606. In some embodiments, a user may search for an entity (e.g., “Tom's Diner”) by entering the entity's name in the search field 604. The search request may be transmitted over a network and search results 612 may be displayed that include information about the entity, such as a link (e.g., “Directions”) to directions to the entity. Additionally, the location 614 of the entity may be displayed on the interactive map 606, such as by the display of an icon 616.

As shown in FIG. 6, a user may be able to view information about the entity by clicking on the icon 616. In response, a window 618 may be displayed having information about the entity. For example, the window 618 may display the name 620 of the entity (e.g., “Tom's Diner”), an address 622 for the entity (e.g., “1234 Street . . . ”), a telephone number 624 of the entity (e.g., “(123) 123-4567”), and a website 626 for the entity. Additionally, the window 618 may display the operating status 628 of the entity as determined by the techniques described above. For example, as shown in FIG. 6, the operating status 628 of the entity may be displayed as “Last verified as open at 1:15 pm.” Based on the techniques described above, this operating status may be based on received status signals having timestamps of or near 1:15 pm. Based on these accumulated timestamps, the status of the entity may be determined to be “open” at 1:15 pm.

Additionally, in some embodiments, user feedback prompt 630 may be displayed in the window 618. For example, as shown in FIG. 6, the text “Not right? Click here to report” may be display in the window 618 below the operating status 628 of the entity. The user feedback prompt 630 may include a link (“here”) to submit verification information and initiate a verification process for the operating status of the entity, as described below and illustrated in FIG. 6. For example, when a user selects (e.g., clicks) on the link included in the user feedback prompt 630, a user may be prompted to enter the current status of the entity or a status and specific time. Based on this verification information, the operating status of the entity may be verified and appropriate actions taken if there is a conflict.

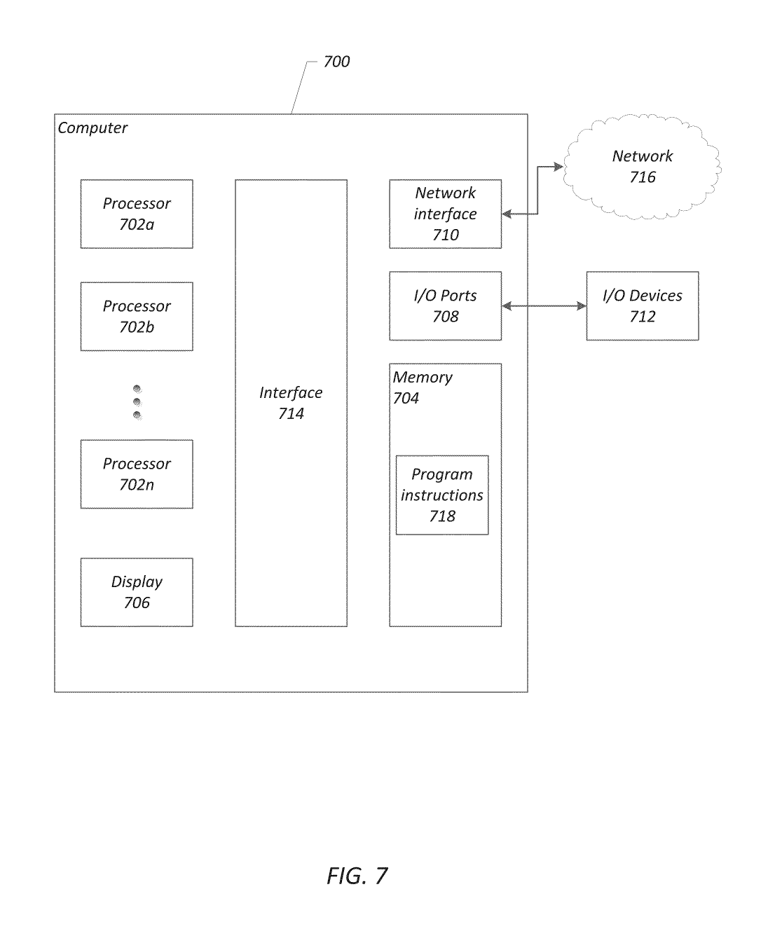

FIG. 7 depicts a computer 700 in accordance with an embodiment of the present invention. Various sections of systems and methods described herein, may include or be executed on one or more computers similar to computer 700. Further, processes and modules described herein may be executed by one or more processing systems similar to that of computer 700.

The computer 700 may include various internal and external components that contribute to the function of the device and which may allow the computer 700 to function in accordance with the techniques discussed herein. As will be appreciated, various components of computer 700 may be provided as internal or integral components of the computer 700 or may be provided as external or connectable components. It should further be noted that FIG. 7 depicts merely one example of a particular implementation and is intended to illustrate the types of components and functionalities that may be present in computer 700.

Computer 700 may include any combination of devices or software that may perform or otherwise provide for the performance of the techniques described herein. For example, computer 700 may include or be a combination of a cloud-computing system, a data center, a server rack or other server enclosure, a server, a virtual server, a desktop computer, a laptop computer, a tablet computer, a mobile telephone, a personal digital assistant (PDA), a media player, a game console, a vehicle-mounted computer, or the like. The computer 700 may be a unified device providing any one of or a combination of the functionality of a media player, a cellular phone, a personal data organizer, a game console, and so forth. Computer 700 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

In addition, the computer 700 may allow a user to connect to and communicate through a network 716 (e.g., the Internet, a local area network, a wide area network, etc.) and may provide communication over a satellite-based positioning system (e.g., GPS). For example, the computer 700 may allow a user to communicate using e-mail, text messaging, instant messaging, or using other forms of electronic communication, and may allow a user to obtain the location of the device from the satellite-based positioning system, such as the location on an interactive map. As shown in FIG. 7, the computer 700 may include one or more processors (e.g., processors 702a-702n) coupled to a memory 704, a display 706, I/O ports 708 and a network interface 710, via an interface 714.

In one embodiment, the display 706 may include a liquid crystal display (LCD) or an organic light emitting diode (OLED) display, although other display technologies may be used in other embodiments. The display 706 may display a user interface (e.g., a graphical user interface). The display 706 may also display various function and system indicators to provide feedback to a user, such as power status, call status, memory status, etc. These indicators may be in incorporated into the user interface displayed on the display 706. In accordance with some embodiments, the display 706 may include or be provided in conjunction with touch sensitive elements through which a user may interact with the user interface. Such a touch-sensitive display may be referred to as a “touch screen” and may also be known as or called a “touch-sensitive display system.”

The processor 702 may provide the processing capability required to execute the operating system, programs, user interface, and any functions of the computer 700. The processor 702 may include one or more processors, such as “general-purpose” microprocessors and general and special purpose microprocessors, such as ASICs. For example, the processor 702 may include one or more reduced instruction set (RISC) processors, such as those implementing the Advanced RISC Machine (ARM) instruction set. Additionally, the processor 702 may include single-core processors and multicore processors and may include graphics processors, video processors, and related chip sets. A processor may receive instructions and data from a memory (e.g., system memory 704). Accordingly, computer 700 may be a uni-processor system including one processor (e.g., processor 702a), or a multi-processor system including any number of suitable processors (e.g., 702a-702n). Multiple processors may be employed to provide for parallel or sequential execution of one or more sections of the techniques described herein. Processes, such as logic flows, described herein may be performed by one or more programmable processors executing one or more computer programs to perform functions by operating on input data and generating corresponding output.

The memory 704 (which may include tangible non-transitory computer readable storage mediums) may include volatile memory and non-volatile memory accessible by the processor 702 and other components of the computer 700. The memory 704 may store a variety of information and may be used for a variety of purposes. For example, the memory 704 may store application instructions, such as the firmware for the computer 700, an operating system for the computer 700, and any other programs or executable code necessary for the computer 700 to function. Program instructions 718 may be executable by a processor (e.g., one or more of processors 702a-702n) to implement one or more embodiments of the present techniques, such as process 300 and process 500 described above. Instructions 718 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, a subroutine. A computer program may or may not correspond to a file in a file system. A program may be stored in a section of a file that holds other programs or data (e.g., one or more scripts stored in a markup language document), in a single file dedicated to the program in question, or in multiple coordinated files (e.g., files that store one or more modules, sub programs, or sections of code). A computer program may be deployed to be executed on one or more computer processors located locally at one site or distributed across multiple remote sites and interconnected by a communication network. In addition, the memory 704 may be used for buffering or caching during operation of the computer 700.

As mentioned above, the memory 704 may include volatile memory, such as random access memory (RAM). The memory 704 may also include non-volatile memory, such as ROM, flash memory, a hard drive, any other suitable optical, magnetic, or solid-state storage medium, or a combination thereof. The memory 704 may store data files such as media (e.g., music and video files), software (e.g., for implementing functions on computer 700), preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish a wireless connection such as a telephone connection), subscription information (e.g., information that maintains a record of podcasts or television shows or other media a user subscribes to), telephone information (e.g., telephone numbers), and any other suitable data.

The interface 714 may include multiple interfaces and may couple various components of the computer 700 to the processor 702 and memory 704. In some embodiments, the interface 714, the processor 702, memory 704, and one or more other components of the computer 700 may be implemented on a single chip, such as a system-on-a-chip (SOC). In other embodiments, these components, their functionalities, or both may be implemented on separate chips. The interface 714 may be configured to coordinate I/O traffic between processors 702a-702n, system memory 704, network interface 710, I/O devices 712, other peripheral devices, or a combination thereof. The interface 714 may perform protocol, timing or other data transformations to convert data signals from one component (e.g., system memory 704) into a format suitable for use by another component (e.g., processors 702a-702n). The interface 714 may include support for devices attached through various types of peripheral buses, such as a variant of the Peripheral Component Interconnect (PCI) bus standard or the Universal Serial Bus (USB) standard.

The computer 700 may also include an input and output port 708 to allow connection of additional devices. For example, the port 708 may be a headphone jack that provides for connection of headphones. Additionally, the port 708 may have both input/output capabilities to provide for connection of a headset (e.g. a headphone and microphone combination). Embodiments of the present invention may include any number of input and output ports 708, including headphone and headset jacks, universal serial bus (USB) ports, Firewire or IEEE-1394 ports, and AC and DC power connectors. Further, the computer 700 may use the input and output ports to connect to and send or receive data with any other device, such as other portable computers, personal computers, printers, etc. For example, in one embodiment the computer 700 may connect to a personal computer via a USB connection to send and receive data files, such as applications, media files, etc.

The computer 700 depicted in FIG. 7 also includes a network interface 710, such as a wired network interface card (NIC), wireless (e.g., radio frequency) receivers, etc. For example, the network interface 710 may receive and send electromagnetic signals and communicate with communications networks and other communications devices via the electromagnetic signals. The network interface 710 may include known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The network interface 710 may communicate with networks (e.g., network 716), such as the Internet, an intranet, a cellular telephone network, a wireless local area network (LAN), a metropolitan area network (MAN), or other devices by wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11a, IEEE 802.11b, IEEE 802.11g or IEEE 802.11n), voice over Internet Protocol (VoIP), Wi-MAX, a protocol for email (e.g., Internet message access protocol (IMAP) or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), Multimedia Messaging Service (MMS), Short Message Service (SMS), or any other suitable communication protocol.

Those skilled in the art will also appreciate that, while various items are illustrated as being stored in memory or on storage while being used, these items or sections of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer 700 may be transmitted to computer 700 via transmission media or signals such as electrical, electromagnetic, or digital signals, conveyed via a communication medium such as a network or a wireless link. Various embodiments may further include receiving, sending or storing instructions or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for determining the operating status of an entity, the method comprising:
receiving over a network, at one or more processors, a plurality of transmissions from a respective plurality of client computers, each transmission generated in response to the detection of a wireless signal corresponding to a position of a locking device of an entity having an open status and a closed status, wherein the locking device is in a first position when the entity has the open status and a second position when the entity has the closed status, the transmission comprising a timestamp and a first entity identifier corresponding to the entity;
accumulating, by the one or more processors, a respective plurality of timestamps of the received plurality of transmissions;
determining based on the stored timestamps, by one or more processors, an operating status of the entity; and
storing, on a memory accessible by the one or more processors, the operating status for the entity in a database entry for the entity.

2. The computer-implemented method of claim 1, comprising receiving, at one or more processors, a request from a requesting client of a second plurality of client computers.

3. The computer-implemented method of claim 2, comprising providing in response to the request, by one or more processors, the operating status of the entity to the requesting client of the second plurality of client computers.

4. The computer-implemented method of claim 3, wherein providing the operating status of the entity to the requesting client of the second plurality of client computers comprises:
annotating, by one or more processors, search results with the operating status, and
transmitting over a network, by one or more processors, the search results and the operating status for display on the requesting client of the second plurality of client computers.

5. The computer-implemented method of claim 3, comprising providing a user feedback prompt with the operating status of the entity, wherein the user feedback prompt enables a user of the requesting client to provide a second operating status of the entity.

6. The computer-implemented method of claim 5, comprising comparing the second operating status to the first operating status and providing a notification based on the comparison.

7. The computer-implemented method of claim 1, wherein the first operating status comprises the open status of the entity or the closed status of the entity.

8. The computer-implemented method of claim 1, wherein the locking device comprises a lock of a door, a lock of a window, a latch of a door, or a latch of a window.

9. The computer-implemented method of claim 1, wherein the first position comprises an unlocked position of the locking device.

10. The computer-implemented method of claim 1, wherein the second position comprises a locked position of the entity.

11. The computer-implemented method of claim 1, comprising determining a first operating time of the entity based on the stored timestamps.

12. The computer-implemented method of claim 1, comprising determining a second operating time of the entity based on the stored timestamps.

13. A non-transitory tangible computer-readable storage medium having executable computer code stored thereon for determining the operating status of an entity, the code comprising a set of instructions that causes one or more processors to perform the following:
receiving over a network, at one or more processors, a plurality of transmissions from a respective plurality of client computers, each transmission generated in response to the detection of a wireless signal corresponding to a position of a locking device of an entity having an open status and a closed status, wherein the locking device is in a first position when the entity has the open status and a second position when the entity has the closed status, the transmission comprising a timestamp and a first entity identifier corresponding to the entity;
accumulating, by the one or more processors, a respective plurality of timestamps of the received plurality of transmissions;
determining based on the stored timestamps, by one or more processors, an operating status of the entity; and
storing, on a memory accessible by the one or more processors, the operating status for the entity in a database entry for the entity.

14. The non-transitory computer-readable storage medium of claim 13, the computer code comprising a set of instructions that causes one or more processors to perform the following: receiving, at one or more processors, a request from a requesting client of a second plurality of client computers.

15. The non-transitory computer-readable storage medium of claim 13, the computer code comprising a set of instructions that causes one or more processors to perform the following: providing in response to the request, by one or more processors, the operating status of the entity to the requesting client of the second plurality of client computers.

16. The non-transitory computer-readable storage medium of claim 15, wherein providing, in response to the request, by one or more processors, the operating status of the entity to the requesting client of the second plurality of client computers by:
annotating, by one or more processors, search results with the operating status, and
transmitting over a network, by one or more processors, the search results and the operating status for display on the requesting client of the second plurality of client computers

17. The non-transitory computer-readable storage medium of claim 13, wherein the first operating status comprises the open status of the entity or the closed status of the entity.

18. The non-transitory computer-readable storage medium of claim 13, wherein the locking device comprises a lock of a door, a lock of a window, a latch of a door, or a latch of a window.

19. A system for determining the operating status of an entity, comprising:
one or more processors;
a database accessible by the one or more processors;
a memory accessible by the one or processors, the memory configured to store computer code the code comprising a set of instructions that, when executed by one or more processors, causes a computer to:
receiving over a network, at one or more processors, a plurality of transmissions from a respective plurality of client computers, each transmission generated in response to the detection of a wireless signal corresponding to a position of a locking device of an entity having an open status and a closed status, wherein the locking device is in a first position when the entity has the open status and a second position when the entity has the closed status, the transmission comprising a timestamp and a first entity identifier corresponding to the entity;
accumulating, by the one or more processors, a respective plurality of timestamps of the received plurality of transmissions;
determining based on the stored timestamps, by one or more processors, an operating status of the entity; and
storing, by the one or more processors, the operating status for the entity in the database.

20. The system of claim 19, wherein the first operating status comprises the open status of the entity or the closed status of the entity.

21. The system of claim 19, wherein the locking device comprises a lock of a door, a lock of a window, a latch of a door, or a latch of a window.

22. The system of claim 19, comprising a sensor configured to operatively respond to the position of the locking device and transmit one or more of the plurality of transmissions.
